(19) United States
(12) Patent Application Publication
(10) Pub. No.: US 2015/0217821 A1
(43) Pub. Date: Aug. 6, 2015

(54) Method of Setting Vehicle Geometry and Structural Joining

(71) Applicant: Ford Global Technologies, LLC, Dearborn, MI (US)

(72) Inventor: Aindrea McKelvey Campbell, Beverly Hills, MI (US)

(73) Assignee: Ford Global Technologies, LLC, Dearborn, MI (US)

(21) Appl. No.: 14/174,110

(22) Filed: Feb. 6, 2014

(51) Int. Cl. B62D 65/00

(52) U.S. Cl. CPC B62D 65/00

(57) ABSTRACT

A method of manufacturing an aluminum-intensive vehicle body by geometry setting major sub-assemblies together and spot welding aluminum panels to set the geometry of the vehicle body. Adjacent sub-assemblies are then joined together with cold-formed joints, such as self-piercing rivets and clinch joints. Resistance spot welds are used to geometry set component parts in the sub-assemblies that are subsequently joined with cold-formed joints to provide structural integrity within the sub-assemblies.

### TECHNICAL FIELD

This disclosure relates to a method of manufacturing a vehicle body by initially welding aluminum components in precise geometrical alignment and subsequently joining the components with cold-formed joining processes.

### BACKGROUND

Individual parts or sub-assemblies are assembled in a “framing operation” for vehicle bodies that are comprised primarily of steel with resistance spot welds to establish the dimensional relationship between the components and sub-assemblies. Spot welding equipment is flexible and can be used to form welds in a variety of different applications with variations in the thickness of parts and the number of panels to be joined by the weld, or part stack-up. Vehicle bodies may be assembled in a framing operation where major sub-assemblies (e.g. a front end sub-assembly, a right side sub-assembly, a left side sub-assembly, a roof sub-assembly, an underbody sub-assembly and a rear end sub-assembly) are placed in fixtures and then welded together to set the geometry of the vehicle. After the geometry is set, “respot” welds are formed along the length of the joints between the major sub-assemblies adding structural joints to strengthen the assembly.

Interest in using alternative materials to steel has driven the development of aluminum-intensive vehicles as the automotive industry continues to focus on reducing the weight of vehicles to meet customer quality expectations and fuel economy standards. Joining methods for aluminum intensive vehicles rely predominantly on self-piercing riveting processes. Self-piercing rivets provide high strength joints and excellent durability performance. Riveting multiple joints with a single rivet gun increases the utilization of the rivet gun in particular where multiple joints are formed along a lengthy seam between two sub-assemblies that have the same gauge and panel stack-up. In addition to self-piercing rivets, clinch joints may be formed to join adjacent parts in aluminum intensive vehicles. In some cases, aluminum parts may be welded together but the lower strength and reduced durability of aluminum welds compared to self-piercing rivets can limit the applicability of such welds for vehicle body applications.

Design requirements associated with each major sub-assembly may be significantly different. Some sub-assemblies may require higher durability and fatigue requirements, while other sub-assemblies may be joined together with a view to absorbing impacts during collisions. Designing vehicle body structures to meet these different design requirements results in the use of different sheet metal gauges and alloys in each sub-assembly.

Self-piercing rivets require specific rivet geometry and die geometry that often must be changed if the gauge of the material or number of panels to be joined varies. In framing operations for major sub-assemblies, there are large variations in sheet metal stack-ups and material gauges. Since one self-piercing rivet tool can be used for only a limited range of joints between major sub-assemblies, many additional robots and self-piercing rivet tools must be used to accommodate the wide range of part thicknesses and stack-ups encountered in framing operations to set the geometry of the major sub-assemblies.

This disclosure is directed to solving the above problems and other problems as summarized below.

### SUMMARY

A method of manufacturing a vehicle body is disclosed that is performed in which the geometry of the vehicle body is set by placing the major sub-assemblies together in fixtures and selectively spot welding together a plurality of aluminum panels that make up the major sub-assemblies. As referred to in this disclosure, the major sub-assemblies include a front end sub-assembly, a right side sub-assembly, a left side sub-assembly, a roof sub-assembly, an underbody sub-assembly, and a rear end sub-assembly. The welds used to geometry set are “manufacturing welds” that are primarily used to set the geometry but are not necessarily sufficient for structural strength and durability. The joints between adjacent major sub-assemblies are subsequently joined together with cold-formed joints such as self-piercing rivets or clinch joints or a combination of self-piercing rivets and clinch joints that provide strong joints required for structural integrity.

The method of manufacturing may further include setting the geometry of the major sub-assemblies by assembling aluminum panels making up the major sub-assemblies in a fixture and spot welding the panels together at spaced locations. After setting the geometry with aluminum spot welds, the panels are joined with self-piercing rivets and clinch joints or a combination of self-piercing rivets and clinch joints to establish structural joints within the major sub-assemblies.

According to one aspect of this disclosure, a method is disclosed for manufacturing a vehicle body that comprises placing a plurality of sub-assemblies together in alignment in a series of fixtures to frame the vehicle. The sub-assemblies are welded together at spaced locations with resistance spot welds. Each of the sub-assemblies is then joined together with each adjacent sub-assembly with cold-formed joints, for example self-piercing rivets and clinch joints.

According to other aspects of this disclosure, the plurality of sub-assemblies may include a front end sub-assembly, a right side sub-assembly, a left side sub-assembly, a roof sub-assembly, an underbody sub-assembly and a rear end sub-assembly. A first one of the sub-assemblies may include a first plurality of aluminum panels that are welded to a second plurality of aluminum panels of a second one of the sub-assemblies. The number of panels in the first plurality of panels may be different than the number of panels in the second plurality of panels. The thickness of panels stacked in the first plurality of panels may be different than the thickness of panels stacked in the second plurality of panels.

The method may further comprise assembling a plurality of aluminum panels together, welding the panels in a specified geometric setting with resistance spot welds, and joining the panels together between the welds with cold-formed joints to form one of the sub-assemblies.

According to other aspects of this disclosure relating to the latter method, a first one of the sub-assemblies may include a first plurality of aluminum panels that are welded to a second plurality of aluminum panels of a second one of the sub-assemblies. The number of panels in the first plurality of panels may different than the number of panels in the second plurality of panels because of the versatility and flexibility of welding tools. A geometry setting weld may be effective even if the thickness of panels stacked in the first plurality of panels is different than the thickness of panels stacked in the second plurality of panels.

The above aspects of this disclosure and other aspects are described below in greater detail with reference to the attached drawings.

### BRIEF DESCRIPTION OF THE DRAWINGS

FIG. 1 is a fragmentary perspective view of a front end sub-assembly assembled to an underbody sub-assembly and a right side sub-assembly that are in position to be geometry set by manufacturing welds in a manufacturing operation for a vehicle body.

FIG. 2 is a perspective view of the front end sub-assembly assembled to the an underbody sub-assembly, the right side sub-assembly and a left side sub-assembly that are in position to be geometry set by manufacturing welds in a manufacturing operation for a vehicle.

FIG. 3 is a perspective view of the front end sub-assembly assembled to the an underbody sub-assembly, the right side sub-assembly, the left side sub-assembly, a rear header and back panel that are in position to be geometry set by manufacturing welds in a manufacturing operation for a vehicle.

FIG. 4 is a perspective view of a roof sub-assembly assembled to the vehicle body shown in FIG. 3 in position to be geometry set by manufacturing welds in a manufacturing operation for a vehicle.

FIG. 5 is a fragmentary perspective view of an inner panel and outer panel joined together by a self-piercing rivet, a clinch joint and a resistance spot weld.

FIG. 6 is a cross-sectional view taken along the line 6-6 in FIG. 5.

FIG. 7 is a cross-sectional view taken along the line 7-7 in FIG. 5.

FIG. 8 is a cross-sectional view of the resistance spot welding operation shown in FIG. 5.

FIG. 9 is a flowchart illustrating the steps of the present method of assembling and setting the geometry of a sub-assembly to establish structural joints within the sub-assembly.

FIG. 10 is a flowchart of the steps of assembling several sub-assemblies of the vehicle body and resistance spot welding geometry setting joints of the vehicle and joining the adjacent modules with self-piercing rivets and clinch joints.

### DETAILED DESCRIPTION

A detailed description of the illustrated embodiments of the present invention is provided below. The disclosed embodiments are examples of the invention that may be embodied in various and alternative forms. The figures are not necessarily to scale. Some features may be exaggerated or minimized to show details of particular components. The specific structural and functional details disclosed in this application are not to be interpreted as limiting, but merely as a representative basis for teaching one skilled in the art how to practice the invention.

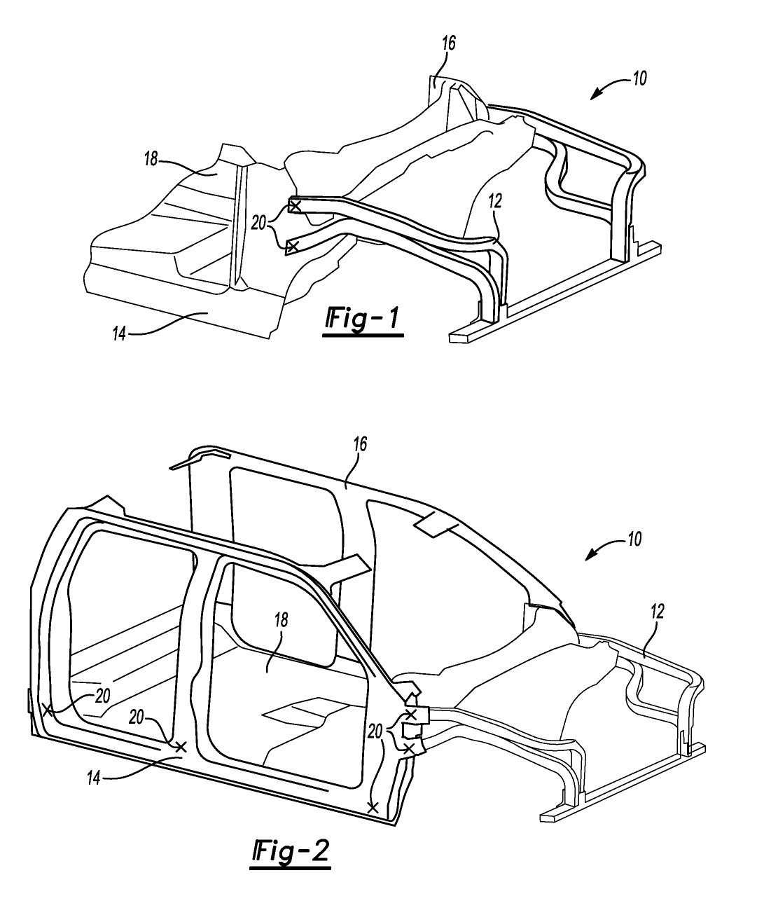

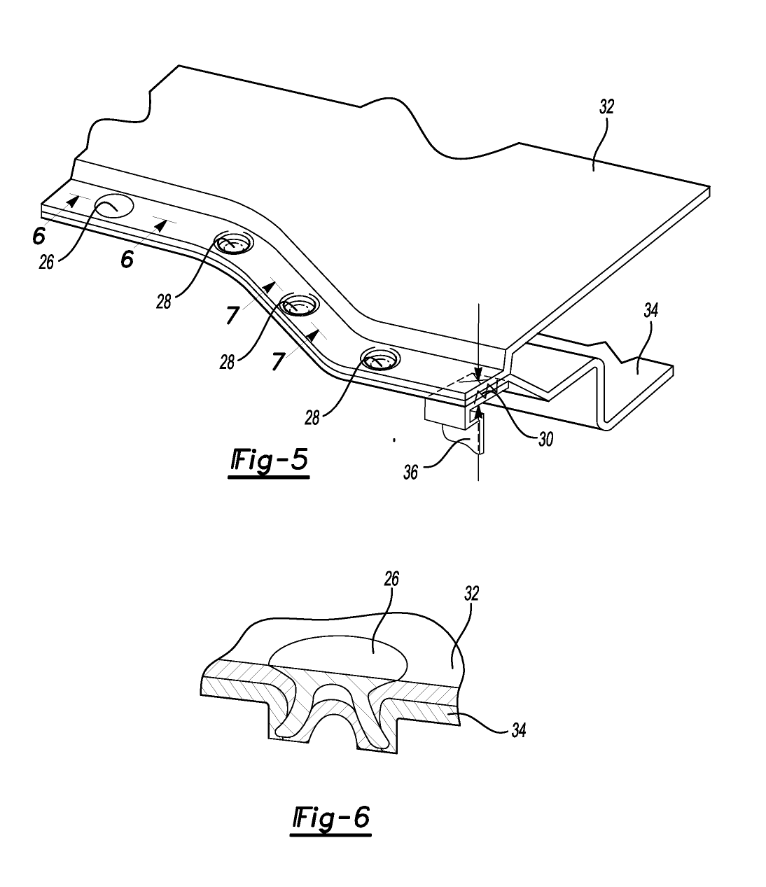

Referring to FIG. 1, a portion of a vehicle body 10 is shown to include a front end sub-assembly 12, a right side sub-assembly 14, a left side sub-assembly 16, and an underbody sub-assembly 18. The sub-assemblies 12-18 are aluminum intensive sub-assemblies that are assembled into an assembly fixture as is well-known in the art and then aluminum resistance spot welds 20 are formed to set the geometry of the sub-assemblies relative to each other, as will be described more specifically below. The resistance spot welds 20 have at least the minimum strength sufficient to withstand loads applied to the partially framed vehicle body 10 during subsequent manufacturing steps. The loads applied include clamp loads, acceleration forces, deceleration forces, and the weight of sub-assemblies that are subsequently attached to the partially assembled vehicle body 10. Adjacent sub-assemblies are subsequently joined to each other with cold-formed joints, such as self-piercing rivets and clinch joints (shown in FIGS. 5-7) that provide the specified structural strength for the vehicle body 10 and manufacturing process capability.

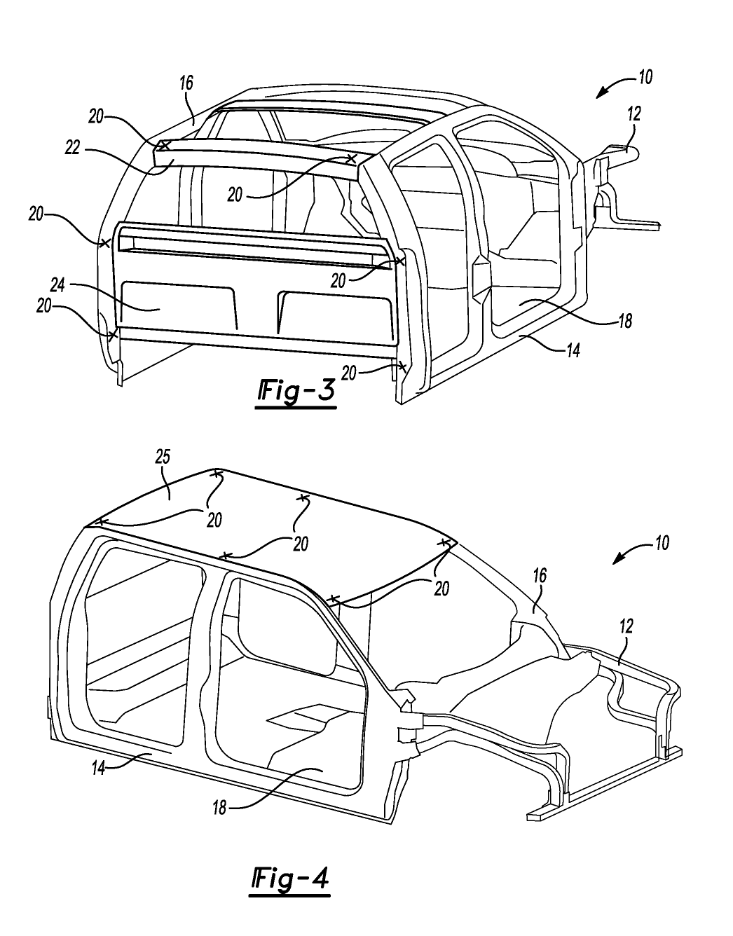

Referring to FIG. 2, the portion of the vehicle body shown in FIG. 1 is shown to include the complete right side sub-assembly 14 and the complete left side sub-assembly 16 assembled to the front end sub-assembly 12 and the underbody sub-assembly 18. Geometry setting welds 20 secure the right side sub-assembly 14 and the left side sub-assembly 16 to the front end sub-assembly 12 and the underbody sub-assembly 18 with sufficient strength to set the geometry of the sub-assemblies as the vehicle body 10 moves through the assembly process until, referring to FIG. 3, a rear header 22 and back panel 24 (the rear header 22 and back panel are referred to either jointly or separately as rear end sub-assemblies) are attached.

Referring to FIG. 3, the portion of the vehicle body 10 shown in FIG. 2 is shown to include rear header 22 and back panel 24 attached to the right side sub-assembly 14, the left side sub-assembly 16, the front end sub-assembly 12 and the underbody sub-assembly 18. Geometry setting welds 20 secure the rear header 22 and back panel 24 to the previously assembled sub-assemblies 12-18 with sufficient strength to set the geometry of the parts as the vehicle body 10 moves through the assembly process until the roof sub-assembly 26 is attached as shown and described with reference to FIG. 4 below.

Referring to FIG. 4, the roof sub-assembly 25 is attached to the partially assembled vehicle body 10 shown in FIG. 3. Geometry setting welds 20 secure the roof sub-assembly 25 with sufficient strength to set the geometry of the sub-assemblies as the vehicle body 10 moves through the rest of the assembly process.

Referring to FIGS. 5 through 8, a self-piercing rivet 26, a clinch joint 28, and a spot weld 30 are shown joining an outer body panel 32 to an inner body panel 34 and a bracket 36. Self-piercing rivets 26 or clinch joints 28 may be used between the above geometry setting steps or after all of the geometry setting welds 20 are completed depending upon accessibility, efficiency and tooling cost factors.

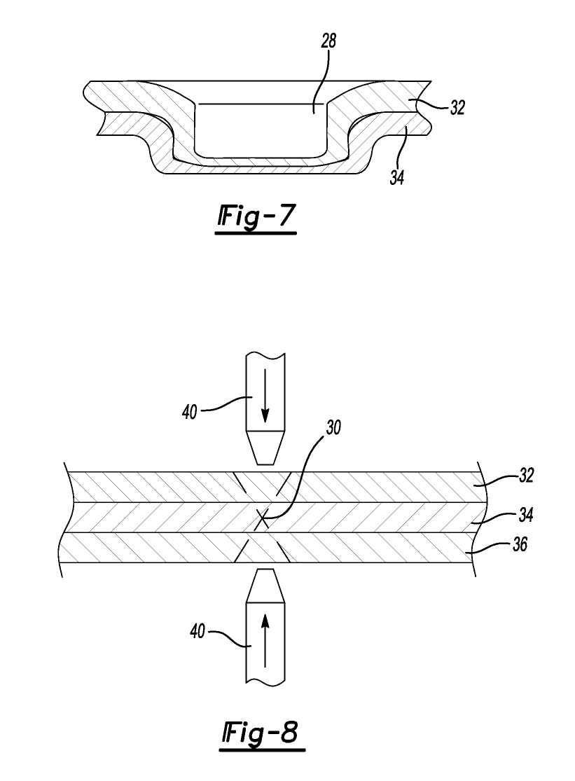

The self-piercing rivet 26 shown in FIGS. 5 and 6 is one example of a cold-formed joint that is shown joining the outer body panel 32 to the inner body panel 34. Referring to FIGS. 5 and 7, another example of a cold-formed joint comprising the clinch joint 28 is shown joining the outer body panel 32 to the inner body panel 34.

Referring to FIGS. 5 and 8, a spot weld 30 is shown joining three panels comprising the outer body panel 32, the inner body panel 34 and the bracket 36. The bracket 36 may also be part of a panel or another part of an adjacent sub-assembly. It should be understood that two or more panels may be required to be welded together at the locations where several sub-assemblies are assembled with geometry setting welds that set the geometry of the vehicle body 10 before inserting the self-piercing rivets 26 and forming clinch joints 28. The outer body panel 32, inner body panel 34 and bracket 36 are all preferably formed of aluminum and may be formed of different aluminum alloys. Spot welds 30 are formed by resistance spot welding using welding electrodes 40 on opposite sides of a stack-up of aluminum body panels. When the welding electrodes 40 are clamped against the stack-up of body panels 32-36, electric current is discharged through the body panels 32-36 to form the resistance spot weld 30 that sets the geometry of the vehicle body. Aluminum resistance spot welds 30 may have lower strength and less durability than self-piercing rivets and are intended to set the geometry of the sub-assemblies of the vehicle body 10.

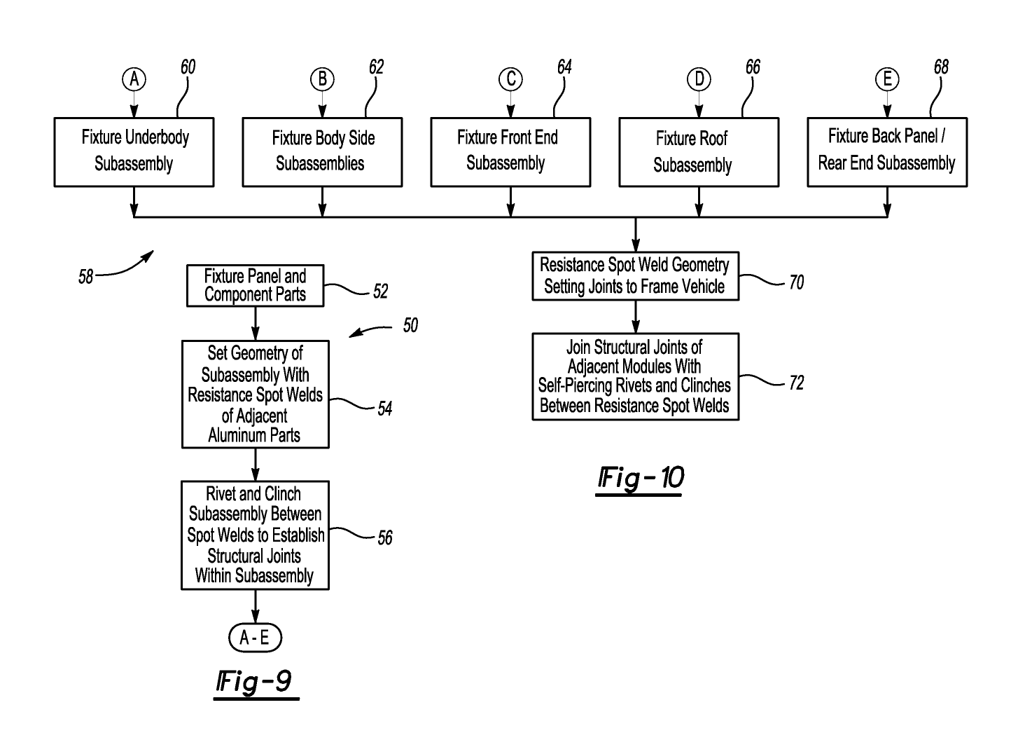

Referring to FIG. 9, a method of assembling major sub-assemblies is illustrated in which panels and component parts are assembled in a fixture at 52 as a first step. The geometry of the sub-assembly is then set at 54 with resistance spot welds connecting adjacent aluminum parts together. The sub-assembly is joined with rivets 26 and/or clinch joints 28 to strengthen structural joints within the sub-assembly. The sub-assemblies formed in the above process correspond to the sub-assemblies 12-18, 22, 24 and 25 described above with reference to FIGS. 1-4. The letters A-E in the flowchart of FIG. 9 are separately assembled as indicated by the separate letters A-E in FIG. 10.

Referring to FIG. 10, the process of setting and joining the sub-assemblies A-E is described. For example, the underbody sub-assembly 18 may be placed in a fixture at 60 and the right and left body side assemblies 14, 16 may be held in a framing fixture at 62. The front end sub-assembly 12 is held in a framing fixture at 64. The roof sub-assembly 25 is held in a framing fixture at 66 and the back panels 24 (rear end sub-assembly) is held in a framing fixture together with the other sub-assemblies at 68. As the parts are assembled into the proper geometric orientation relative to each other, the geometry is set by resistance spot welds at 70. The vehicle body 10 is framed in sequence with the resistance spot welds 20 in the aluminum panels setting the geometry. After the body geometry is set with the spot welds 20, adjacent modules, or sub-assemblies, are joined with cold-formed structural joints. The cold-formed structural joints include self-piercing rivets 26 that are either inserted into the sub-assemblies and clinch joints 28 that are formed into the sub-assemblies between the resistance spot weld joints.

Welding aluminum can be difficult and the strength of a welded joint may not be sufficient to meet the structural design requirements. One advantage of welding over self-piercing rivets is that the weld tooling is more flexible. The same weld gun may be used to join parts including different numbers of panels in the stack-up and also may be used to join parts having different material thicknesses or gauges. For example, the same weld gun or type of weld gun tooling may be used to join a front end sub-assembly and also may be used to assemble body sides and underbody or roof sub-assemblies that have different types of aluminum alloys and material gauges.

Rivets provide increased strength and may be better suited to meet design requirements for a front end sub-assembly being joined to the vehicle body because they offer high strength, durability and can meet fatigue requirements. Moreover, self-piercing riveted joints offer high dynamic strength which may be advantageous in body side sub-assemblies which must be joined in such a way that they meet side impact crash requirements.

Clinch joints may be used to reduce costs where less joint strength is required. The use of self-piercing rivets are better suited to joints that include three or possibly four panels that are joined together. Cold-formed joints are sensitive to materials and the gauges of the panels involved in a given joint. A given self-piercing rivet gun or clinch tool may be used to form many joints where a region of similar panel combinations of a set of sub-assemblies is to be joined.

The resistance spot weld joints used for geometry setting may be classified as “manufacturing welds” that are added for manufacturing purposes to facilitate setting the geometry of the parts to be assembled. Joints that are required to meet structural requirements in the vehicle body may then be inserted as cold-formed joints, such as self-piercing rivets and clinch joints. These joints may be formed in groups where the same parts are to be joined in one area and can be used to meet exacting structural requirements of the vehicle body.

The disclosed method provides advantages over prior art assembly manufacturing techniques because it enables greater flexibility in geometry setting operations. This added flexibility reduces production tooling costs and reduces the investment in robots and other tooling used in assembly operations.

While specific embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A method of manufacturing a vehicle body comprising:
fixturing a plurality of sub-assemblies together in alignment to frame the vehicle;
welding each of the sub-assemblies together in spaced locations with resistance spot welds; and
joining each of the sub-assemblies together with adjacent sub-assemblies with cold-formed joints.

2. The method of claim 1 wherein the plurality of sub-assemblies include a front end sub-assembly, a right side sub-assembly, a left side sub-assembly, a roof sub-assembly, an underbody sub-assembly and a rear end sub-assembly.

3. The method of claim 1 wherein the cold-formed joints include self-piercing rivets and clinch joints.

4. The method of claim 1 wherein a first one of the sub-assemblies includes a first plurality of aluminum panels that are welded to a second plurality of aluminum panels of a second one of the sub-assemblies, wherein a number of panels in the first plurality of panels is different than a number of panels in the second plurality of panels.

5. The method of claim 1 wherein a first one of the sub-assemblies includes a first plurality of aluminum panels that are welded to a second plurality of aluminum panels of a second one of the sub-assemblies, wherein a thickness of panels stacked in the first plurality of panels is different than a thickness of panels stacked in the second plurality of panels.

6. The method of claim 1 further comprising:
fixturing a plurality of aluminum panels together;
welding the panels in a specified geometric setting with at least two resistance spot welds; and
joining the panels together between the welds with cold-formed joints to form one of the sub-assemblies.

7. A method of manufacturing a vehicle body comprising:
assembling a first sub-assembly to a second sub-assembly together in alignment to frame the vehicle;
welding the first sub-assembly to the second sub-assemblies in at least two spaced locations with resistance spot welds, wherein the sub-assemblies are attached to each other to set the geometry of the sub-assemblies of the vehicle body with a minimum degree of strength to withstand loads applied during assembly operations; and
joining the first sub-assembly together with the second sub-assembly with a plurality of cold-formed joints to increase the strength of the attachment of the first sub-assembly to the second sub-assembly.

8. The method of claim 7 wherein the loads applied during assembly operations consist essentially of:
clamp loads;
acceleration forces;
deceleration forces; and
the weight of sub-assemblies that are later attached to the vehicle body.

9. The method of claim 7 wherein the cold-formed joints include self-piercing rivets and clinch joints.

10. The method of claim 7 wherein a first one of the sub-assemblies includes a first plurality of aluminum panels that are welded to a second plurality of aluminum panels of a second one of the sub-assemblies, wherein a number of panels in the first plurality of panels is different than a number of panels in the second plurality of panels.

11. The method of claim 7 wherein a first one of the sub-assemblies includes a first plurality of aluminum panels that are welded to a second plurality of aluminum panels of a second one of the sub-assemblies, wherein a thickness of panels stacked in the first plurality of panels is different than a thickness of panels stacked in the second plurality of panels.
